(19) United States
(12) Patent Application Publication
(10) Pub. No.: US 2023/0303797 A1
(43) Pub. Date: Sep. 28, 2023

(54) RECYCLING SYSTEM AND PROCESS USING SUBCRITICAL AND/OR SUPERCRITICAL WATER

(71) Applicant: SEAUCIEL LLC, Mentor, OH (US)

(72) Inventor: Paul BOULIER, Mentor, OH (US)

(21) Appl. No.: 18/020,778

(22) PCT Filed: Nov. 19, 2021
(86) PCT No.: PCT/US2021/060106

§ 371 Date: Feb. 10, 2023

Related U.S. Application Data
(60) Provisional application No. 63/116,187, filed on Nov. 20, 2020.

(51) Int. Cl. C08J 11/06

(52) U.S. Cl. CPC C08J 11/06; C08J 2323/08; C08J 2323/10; C08J 2367/02; C08J 2377/00

(57) ABSTRACT

Provided is a system, process, and method for the recycling of waste plastics. The recycling system, process, and method may comprise sorting of comingled waste. The sorting of comingled waste may include sorting into, for example, like polymer groups or families of plastic materials. The recycling system, process, and method may comprise processing of a sorted waste, including processing of the sorted plastic waste. The processing of the sorted plastic waste may include grinding and mixing, a supercritical or subcritical fluid treatment and sterilization, and extrusion to create and provide a homogenous precursor plastics blend. The precursor plastics blend may then be further extruded and refined to remove water and other low molecular weight material, and may be customized with additives to provide a value-added recycled plastic material. The additives may include colorants, flame retardants, fillers, fiber, identifiers, and the like, and may be combined in a ratio with virgin plastics, to impart specific properties on the value-added recycled plastic material based on its subsequent use in remanufacture and tracking. One or more of the recycling steps or phases may provide at least one of speed, accuracy, or cleanliness and minimization of human contact with waste materials.

### CROSS REFERENCE TO RELATED APPLICATIONS

This application claims priority to U.S. Provisional Patent Application No. 63/116,187 entitled “Recycling System and Process Using Supercritical Water” filed on Nov. 20, 2020, which is hereby incorporated by reference in its entirety.

### FIELD OF THE INVENTION

The present disclosure generally relates to recycling systems and processes and, more specifically, to recycling systems and processes that include subcritical and supercritical methods and technology to produce value-added, comingled recycled polyblends and compounds.

### BACKGROUND

Single-use plastic items, “disposable” plastic packaging, and plastic consumer items generally found mass popularity in the 20th Century and quickly became ubiquitous in modern society. Due to the low costs of production, desired material properties, and wide variety of use applications, plastic has in many instances replaced its glass, paper, and metal counterparts. For example, plastics are durable, lightweight, offer protection from contaminants, microbes, pests, and the environment, including humidity, and can provide a more sterile or hygienic alternative than other reusable materials and items. The production of plastics is also cost-effective and provides desired convenience in its ability to be single-use and disposable.

Since the 1950s, it is estimated that over 8.3 billion metric tons of plastics have been produced, with more than half of that in the past 15-20 years alone. (https://www.universityofcalifornia.edu/news-origginal/weve-created-83-billion-tons-plastic-waste-and-counting.) As it stands, tens of billions of pounds of synthetic plastics are produced globally on an annual basis. In the U.S., it is estimated that 13% of total municipal solid waste is plastics, which translates to about 68 billion pounds of plastic per year going into the waste stream. Similarly, out of 140 million tons of materials that are landfilled each year in the U.S., plastics accounted for over 20% of that total in 2017. Further, it is estimated that more than 40% of non-fiber reinforced plastic comes from plastic packaging alone, much of which is used in single-use items. (https://www.nationalgeographic.com/news/2017/07/plastic-produced-recycling-waste-ocean-trash-debris-environment/.) Even outside of single-use items and “disposable” packaging, polymers and synthetic plastics are used in many other industries as well, including in durable goods; electronics and electrical applications; building and construction; textiles; machinery, transportation, and automotive applications; medical devices, equipment, and personal protective gear; food packaging, clothing, household items, and other consumer goods; and the like. Regarding plastics in particular, there is demand for industry and government compliant plastic materials (FDA, EPA, and the like) in food, medical, and similar industries. As an example, in medical and food applications the sterility and hygiene that single-use plastic items and “disposable” plastic packaging provide may not be replicated by the use of other alternative materials.

Although plastics may provide unique and unmatched benefits, the overwhelming use of plastics presents many environmental implications. For instance, most plastics are produced from increasingly scarce and finite fossil sources, such as petroleum and natural gas. Moreover, the manufacturing of plastics from these fossil sources produces CO₂ as a by-product, the emission of which is considered to be a leading cause in climate change and global warming. While some sources indicate that the initial production of greenhouse gases may be less for plastics compared to its other material counterparts, the single-use and disposable nature of plastics results in a greater overall carbon footprint than that of reusable items made of these material counterparts.

In addition to the criticisms surrounding the production of plastics, there is also criticism surrounding the disposal of plastics after use. It is reported that just 9% of the world's multibillion tons of plastic has been recycled. The remaining 91% of all plastics ends up in landfills or littered on the ground, in oceans, and in waterways. It is estimated that 8 million metric tons of plastics each year ends up in the ocean alone. (https://www.nationalgeographic.com/news/2017/07/plastic-produced-recycling-waste-ocean-trash-debris-environment/.) Single-use plastics in particular, especially smaller items like straws, cutlery, bottles, bottle caps, bags, gloves, and the like, often end up littered or are unintentionally carried through the environment by wind or water, for example. These plastic items are often deemed unrecyclable and thereby are not accepted by recycling centers because, for example, they fall into the crevices of recycling machinery or are otherwise considered hard to recycle due to, for example, contamination or being mixed with other non-compatible materials. Recycling processes and machinery are also expensive and there is a lack of incentive to promote recycling and to further refine and optimize the processes and machinery. Moreover, even when disposed of in landfills or waste containers, plastics do not biodegrade. Instead, plastics slowly break down into smaller pieces of plastic called microplastics, which may pose risks to humans, animals, and the environment in ways that are still not totally understood. Cumulatively, the consequences of using single-use plastics and “disposable” plastics is prohibitive of the continued manufacture of these same products and materials.

Recycling, then, is a priority in order to reap the full benefits and usability of plastics, and even single-use or “disposable” plastics, without the undesired consequences of a surplus of waste and the negative impact on the environment. Recycling of materials may offer numerous benefits including: conserving finite and scarce natural resources; saving energy that would otherwise be used in the manufacturing and processing of new virgin plastics; reducing negative impacts on the environment from the manufacturing and processing new virgin plastics, such as greenhouse gas emissions; and reducing waste that is littered or sent to landfills and incinerators by reprocessing existing and already manufactured plastic materials into new products. Additionally, the recyclable materials may be acquired locally and, as it stands, in abundance, increasing use of locally sourced materials and generating local business while decreasing reliance on outside industry.

Nevertheless, conventional recycling process and management of plastic waste fall short and do not allow for adequate reuse of plastic materials to minimize the production of new virgin plastics. For example, critical infrastructure elements—including collection, sorting, processing, and end-use application facilities and their harmonization—remain only in early development. In 2016, it was found that at least 50% of polyethylene (PE) material purchased in the U.S. for recycling was of unsuitable quality for further processing. Additionally, current plastics processing technology itself is labor-intensive and involves high-cost mechanical recycling. Gaps in supply and end-use demand for recycled plastic material remain. Moreover, current recycled plastics may be of inferior quality when compared to new virgin plastics, thus not only limiting the applications of use of recycled plastics, but furthermore leaving a need for the continued manufacture of new virgin plastics. Domestic recycling capabilities in the U.S. has also seen a recent increase in need when China stopped importing all comingled waste from the U.S. and other countries in 2018.

Although there may exist a high volume plastic waste, much of this waste is considered unsuitable for recycling and, for what is considered recyclable, is not able to be recycled easily and consistently to provide an adequate and desired end product. As a result, many collection systems are under economic pressure, restricted in their capabilities and scale, and may actually be overwhelmed with waste material without sufficient systems and processes in place. This has led to insufficient recycling capabilities, which in turn results in a higher prevalence of littering or improper disposal of plastics into the environment, and an increased amount of plastics disposed of in landfills or incinerated.

Other contributing factors that have prevented large scale recycling efforts also include:
lack of economic incentives to promote recycling either by private citizens or industry;
lack of education to help the public better understand the benefits of and value in recycling, inconsistent systems at the local, state, and federal levels to actively support use and management of materials;
uncertainty globally regarding standards of recycling and who bears the responsibility of recycling;
focus on single use stream recycling of co-mingled products that include plastics, glass, paper, metal, etc., which may complicate the ability to separate and reuse materials, increase costs, and discourage the public to take interest in/invest in recycling systems, and;
contamination of the material to be recycled by other waste materials (for example, in the case of plastics, it is estimated that >25% of the disposed materials are contaminated with food or other non-plastic contaminants).

### SUMMARY OF THE INVENTION

The present technology provides solutions to one or more issues associated with current efforts to recycle plastic materials. The present system and methods allow for sorting of comingled plastic waste and subsequent treatment of the separated plastic materials to form a recycled plastic material. For example, the recycled material can be reprocessed to make recycled plastic products. In an embodiment, the recycled material can be reprocessed, with or without virgin plastics, to make recycled plastic products. Additionally, the recycled material can be further processed with other materials to provide value-added materials. Materials formed from the recycled materials that are further modified to or processed with additional components may be referred to herein as upcycled plastic products. It is noted that the terms recycled and upcycled may be used interchangeably throughout this application and that both recycled and upcycled plastic materials and products are herein contemplated and disclosed. This may allow for reduction of the use of virgin plastic materials and also reduce the amount of materials disposed in landfills, both of which may be desirable environmentally. Additionally, the system and methods may allow for the development of customized recycled materials that may be used in the reproduction and remanufacture of plastic goods and items.

Conventional mechanical recycling generally results in low-value recycled materials and requires higher ratios of virgin plastics in order to be used in creating new recycled products. Chemical recycling generally results in a breakdown of plastic components to their monomers (sometimes referred to as hydrothermal liquefaction (HTL)). The present systems and methods described herein, in contrast, do not break the plastic components to their monomers (unlike HTL) but still are able to provide higher quality recycled materials and a homogenous blend (compared to mechanical grinding). The present systems and methods can use secondary sorting to separate plastics into different identifying groups and can sterilize and remove non-compatible elements from the raw plastic materials, which are processes not typically used or able to be used in chemical and mechanical recycling respectively.

Provided is a system, process, and method for the recycling of waste material. The recycling system, process, and method may comprise sorting of comingled waste. The sorting of comingled waste may include sorting into, for example, like polymer groups or families of plastic materials. The recycling system, process, and method may comprise processing of a sorted waste, including processing of the sorted plastic waste. The processing of the sorted plastic waste may include a preliminary step of grinding and mixing the sorted plastic waste material, washing and/or sterilizing the sorted plastic waste material with a supercritical or subcritical fluid, and treating the sorted plastic waste material with a supercritical or subcritical fluid (that may be the same or different than the prior supercritical or subcritical fluid or have the same or different supercritical or subcritical conditions) to produce a polymer blend.

The polymer blend obtained from the treatment process is considered to be a recycled plastic material. In one embodiment, the polymer blend can itself be used to form a new plastic product. The polymer blend, for example, may be reprocessed into a recycled product on-site or may be sold to manufacturers or other companies to be reprocessed into a recycled product in another facility. In another embodiment, the polymer blend may be used as a precursor polymer blend, also referred to herein as a precursor blend, to provide a customized or value-added recycled or upcycled plastic material. For example, the recycling system, process, and method may further comprise compounding the precursor polymer blend treating and refining the precursor polymer blend to remove water and other low molecular weight material, and customizing the precursor polymer blend with additives to provide a value-added recycled or upcycled plastic material. The additives may include colorants, flame retardants, fillers, fiber, identifiers, and the like, and may be combined in a ratio with virgin plastics, to impart specific properties on the value-added recycled plastic material based on its subsequent use in remanufacture and tracking. The value-added plastic material or value-added blend, for example, may be reprocessed into an upcycled product on-site or may be sold to manufacturers or other companies to be reprocessed into a upcycled product in another facility. One or more of the recycling steps or phases may provide at least one of speed, accuracy, or cleanliness and minimization of human contact with waste materials.

As will be appreciated, the respective components of the system can be provided individually or together to form a complete system. For example, the sorting system can be a free standing system to collect groups of sorted plastic waste material, which can then be shipped to a treatment center/facility where the sorted plastic waste material will be treated (such as by the supercritical or subcritical water treatment process of the present technology or another plastic treatment process as may be desired). In another embodiment, the entire process, e.g., sorting, supercritical or subcritical fluid treatment, compounding, etc., can be self-contained and located at a single processing site.

Provided is a process for recycling plastic materials. In an embodiment, the process may comprise: treating a set of plastic materials with a fluid under (i) subcritical conditions and/or (ii) supercritical conditions to provide a precursor blend of plastic. In an embodiment, the fluid may be water. In an embodiment, the subcritical conditions may include at least one of a temperature of about 110-372° C. or a pressure of about 700-3100 psi. In an embodiment, the subcritical conditions may include a temperature that is at or greater than the melting point of the plastic materials.

In an embodiment, treating may further comprise mechanically blending the plastic materials during treatment with the fluid. In an embodiment, the set of plastics may comprise a single type of polymeric material. In an embodiment, the single type of polymeric material may include polypropylene or polyethylene. In an embodiment, the single type of polymeric material may comprise two or more monomeric components. In an embodiment, the set of plastics may comprise two or more types of plastic materials. In an embodiment, the single type of polymeric material may include polypropylene and polyethylene. In an embodiment, the precursor blend of plastic may be a homogenous blend. In an embodiment, the set of plastic materials may not be broken down into their monomeric components.

In an embodiment, the set of plastic materials may comprise at least one plastic selected from a polyolefin, an amorphous polymer, a polyester, a polyamide, or a combination of two or more thereof. In an embodiment, the set of plastic materials may include a plastic selected from polyethylene (PE), polypropylene (PP), thermoplastic olefin (TPO), polymethylpentene (PMP), polybutene-1 (PB-1), polyisobutylene (PIB), ethylene propylene rubber (EPR), ethylene-octene copolymers, olefin block copolymers, propylene-butane copolymers, poly(a-olefin)s, ethylene propylene diene monomer (EPDM) rubber, high density polyethylene (HDPE), low density polyethylene (LDPE), linear low density polyethylene (LLDPE), very-low-density polyethylene (VLDPE), ultra-low-density polyethylene (ULDPE), or medium-density polyethylene (MDPE), or a combination of two or more thereof. In an embodiment, the set of plastic materials may comprise a plastic material selected from polyethylene (PE), polypropylene (PP), or a combination of polyethylene (PE) and polypropylene (PP).

Provided is a method for recycling plastic materials. In an embodiment, the method may comprise (one or more or all of): sorting co-mingled plastic waste into one or more groups of a set of plastics, grinding and mixing the set of plastics into a mix, subjecting the set of plastics to any of the preceding processes for recycling plastic materials to provide a precursor blend of plastic; conveying the precursor blend of plastic to compounding equipment; removing residual fluid or water and other low-molecular weight materials; and optionally incorporating other additives or unrecycled plastics to provide specific physical, thermal, mechanical, or aesthetic properties in a value-added recycled product. In an embodiment, the precursor blend may be homogenous.

Provided is a system for recycling plastic materials. In an embodiment, the system may comprise: a sorting system for separating co-mingled plastic materials into one or more groups of sorted plastic materials based on selected characteristics of the sorted plastic materials; a treatment system for treating one of the one or more groups of the sorted plastic materials via supercritical or subcritical fluid to create a precursor blend; and a compounding system for compounding the precursor blend to provide a recycled plastic material. In an embodiment, the system may further include a pre-sorting system for separating co-mingled waste including two or more of glass, paper, metals, compost, plastics, and combinations of two or more thereof, wherein the co-mingled plastic materials may be isolated from the co-mingled waste. In an embodiment, the sorting process may include at least one of artificial intelligence and robotics.

In an embodiment, the one or more groups of sorted plastic materials may include a polyolefin, an amorphous polymer, a polyester, a polyamide, or a combination of two or more thereof. In an embodiment, the one or more groups of sorted plastic materials comprises a plastic material selected from polyethylene (PE), polypropylene (PP), thermoplastic olefin (TPO), polymethylpentene (PMP), polybutene-1 (PB-1), polyisobutylene (PIB), ethylene propylene rubber (EPR), ethylene-octene copolymers, olefin block copolymers, propylene-butane copolymers, poly(a-olefin)s, ethylene propylene diene monomer (EPDM) rubber, high density polyethylene (HDPE), low density polyethylene (LDPE), linear low density polyethylene (LLDPE), very-low-density polyethylene (VLDPE), ultra-low-density polyethylene (ULDPE), or medium-density polyethylene (MDPE). In an embodiment, the one or more groups of sorted plastic materials may comprise a plastic material selected from polyethylene (PE), polypropylene (PP), or a combination of polyethylene (PE) and polypropylene (PP).

In an embodiment, the treatment system may include an initial processing step of grinding and mixing the sorted plastic materials to obtain a component mix of the sorted plastic materials. In an embodiment, the treatment system may include a sterilization step, wherein the component mix of the sorted plastic materials are inputted into a subcritical water processing chamber to obtain a sterilized component mix of the sorted plastic materials. In an embodiment, the treatment system may include a subcritical and/or supercritical processing step, wherein the sterilized component mix of the sorted plastic materials are inputted into a subcritical and/or supercritical water processing chamber to provide the precursor blend. In an embodiment, the subcritical water processing chamber and the subcritical and/or supercritical water processing chamber may be the same vessel.

In an embodiment, the precursor blend may be homogenous. In an embodiment, the subcritical processing step may occur at a temperature of 110-372° C. or a pressure of 700-3100 psi. In an embodiment, the precursor blend may have the same plastic properties or identity as the one or more groups of sorted plastic materials. In an embodiment, the system may further comprise adding at least one additive to the precursor blend to provide a value-added blend. In an embodiment, the at least one additive may be a colorant, flame retardant, filler, fiber, chemical identifier, tracker, or taggant. In an embodiment, the at least one additive may provide at least one of an added physical property or aesthetic property that is not present in the precursor blend. In an embodiment, the system may further comprise adding virgin or unrecycled plastics to the precursor blend to provide a combination blend.

These and other aspects and embodiments of the present technology are further understood and described in the Detailed Description that follows.

### BRIEF DESCRIPTION OF THE DRAWINGS

The present teachings may be better understood by reference to the following detailed description taken in connection with the following illustrations, wherein:

FIG. 1 depicts an embodiment of a recycling process starting with comingled waste in accordance with aspects of the present disclosure;

FIG. 2 depicts an embodiment of a recycling process starting with sorted polymer groups in accordance with aspects of the present disclosure;

FIG. 3 depicts another embodiment of a recycling process starting with comingled waste in accordance with aspects of the present disclosure;

FIG. 4 depicts an embodiment of a recycling process starting with comingled waste in accordance with aspects of the present disclosure;

FIG. 5 depicts an embodiment of a recycling process starting with comingled waste in accordance with aspects of the present disclosure.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a system, process, and method for the recycling of waste material comprising waste plastic material. In one embodiment, the recycling system, process, and/or method comprises sorting of comingled waste. The sorting of comingled waste may include sorting the waste plastic materials into groups of waste plastic material based on one or more selected characteristics of the waste plastic materials. This may include, for example, separating the waste plastic materials into types, groups, classes, or families of waste plastic materials based on the chemical make up of the waste plastic material. So, groups of waste plastic materials, which may also be referred to as sorted plastic waste, are created based on the polymer/chemical makeup of the waste plastic materials.

In an embodiment, the sorted plastic waste is treated and processed to form a useable recycled plastic material suitable for remanufacture. Processing of the sorted plastic waste may include grinding and mixing, treating the sorted plastic waste with a supercritical or subcritical fluid, or a near supercritical or subcritical fluid, to remove unwanted contaminants, to sterilize the waste plastic material, and to blend the waste plastic material to form a precursor blend, and compounding the precursor blend as desired to create a recycled plastic material suitable for use to form an end product.

For the purposes of this disclosure, the term supercritical fluid may include a fluid state at or above a critical state of the fluid, i.e. at a temperature and a pressure above the fluid's critical point, where distinct liquid phases and gas phases do not exist or the fluid exhibits particular properties and intermediate behavior that is between that of a liquid and a gas. Carbon dioxide, for example, is understood as having a critical temperature at about 30-31° C. and critical pressure at about 73-74 bar (1058-1073 psi), and a critical point at these temperatures and pressures. Water, for example, is understood as having a critical temperature at about 373-374° C. and critical pressure at about 220-221 bar (3190-3205 psi), and a critical point at these temperatures and pressures. A supercritical state may be a state at or above these noted critical points and a subcritical state may be a state at or below these noted critical points.

Subcritical conditions for the purposes of this disclosure, may include a fluid state below the critical state of the fluid, i.e. having a temperature or a pressure below the fluid's critical point or having a temperature and a pressure below the fluid's critical point, and may also be referred to as near supercritical conditions or conditions below supercritical conditions. While the temperature of the subcritical conditions may be below the supercritical temperature, the temperature of the subcritical conditions is selected to be above the melting point of the plastic material(s) being treated.

For example, subcritical conditions, for water, may include temperatures below 373° C. or pressures below 3190 psi (or both). For example, subcritical conditions may require a minimum temperature above the thermal melting point of plastics to be recycled. Pressure conditions may depend on temperature conditions. For example, if the temperature is closer to the supercritical temperature of the fluid, e.g., the higher range of subcritical temperatures, lower pressures may be used to form the desired recycled blend. If the temperature is closer to the thermal melting point of plastics, e.g., the lower range of subcritical temperatures, higher pressures may be used to form the desired recycled blend. Similarly, agitation and ratio of the plastics to the subcritical fluid can be modified based on temperature and pressure conditions in order to carry out the described recycling processes and systems. For example, increased agitation may enable lower temperatures or pressures. For example, increased subcritical fluid may enable lower temperatures or pressures.

It is understood that carbon dioxide and water are not the only supercritical fluids and that many other fluids may be used at their subcritical or supercritical states and applied to this disclosure. For example, other fluids that may be used include ethane, propane, ethylene, propylene, etc.

It is noted that these particular subcritical and supercritical points, temperatures, and pressures can vary based on literature, conversions, and measurement techniques, and should be understood as a range with a +/− of several units. Moreover, any disclosures of supercritical or subcritical states in this disclosure should also be understood as including near supercritical and near subcritical states, where “near” may be understood as within 10% if the described point or range.

In embodiments, the subcritical water includes conditions of (i) a temperature of from about 110 to about 372° C., about 225 to about 350° C., about 250 to about 325° C., about 290 to about 320° C., or about 300 to about 310° C., and/or (ii) a pressure of from about 700 to about 3100 psi, about 750 to about 3000 psi, about 800 to about 2500 psi, about 900 to about 2000 psi, or about 1000 to about 1200 psi. The subcritical water may include conditions that are less than the supercritical or near supercritical conditions.

Compounding of the precursor blend can include subjecting the precursor blend to any suitable compounding or mixing operation to sufficiently blend, homogenize, or otherwise mix the precursor blend. In one embodiment, the compound operation comprises extrusion or other operations to remove water and other low molecular weight material, and to optionally customize the precursor blend with additives to provide a value-added recycled plastic material. Compounding may include the addition of virgin polymeric material to provide certain properties to the recycled product. Additionally other additives can be added to adjust the properties or appearance of the recycled plastic material. The additives may include, but are not limited to, colorants, flame retardants, fillers, fiber, chemical identifiers or taggants, and the like, and may be combined in a ratio with virgin plastics, to impart specific properties on the value-added recycled plastic material based on its subsequent use in remanufacture and tracking. One or more of the recycling steps or phases may provide at least one of speed, accuracy, or cleanliness and minimization of human contact with waste materials.

In an embodiment, disclosed is a process 100 for making polymer compounds, comprising the steps of: (1) using artificial intelligence and robotics to provide secondary sorting 1000 of comingled recycled plastics waste; (2) grinding and mixing of the partially-sorted comingled waste; (3) using supercritical or subcritical fluid processes to wash, sterilize, and at least partially blend 2000 the comingled waste plastics, where the fluid used is supercritical or subcritical water; (4) conveying the admixture to blending/compounding equipment; (4) removing residual fluid or water and other low-molecular weight materials; (5) optionally incorporating other additives 3000, such as, but not limited to, colorants, flame retardants, fillers, fiber, and other articulate materials or other adjuvants, either alone or with other virgin plastics to impart specific physical, thermal, mechanical, or aesthetic properties for use in value-added products for packaging, small/large appliance, electrical/electronics, industrial and consumer products, etc. In an embodiment, the minimum recycled plastic content in a recycled product may be 20% or greater, for example, 20% to 100%, 30% to 90%, 40% to 70%, 50% to 60% and any point therebetween, including 20%, 30%, 40%, 50%, 60%, 70%, 80%, 90%, 95%, 100%, etc. While other recycling processes can result in lower value recycled plastic materials and require relatively high mixtures with virgin plastics to be processed into new plastic products, the current system, methods, and resulting homogenous copolymer blends may allow for increased ratios and use of the recycled plastics into new plastic products, including up to 100% of recycled plastics from the current systems, methods, and blends, into new plastic products.

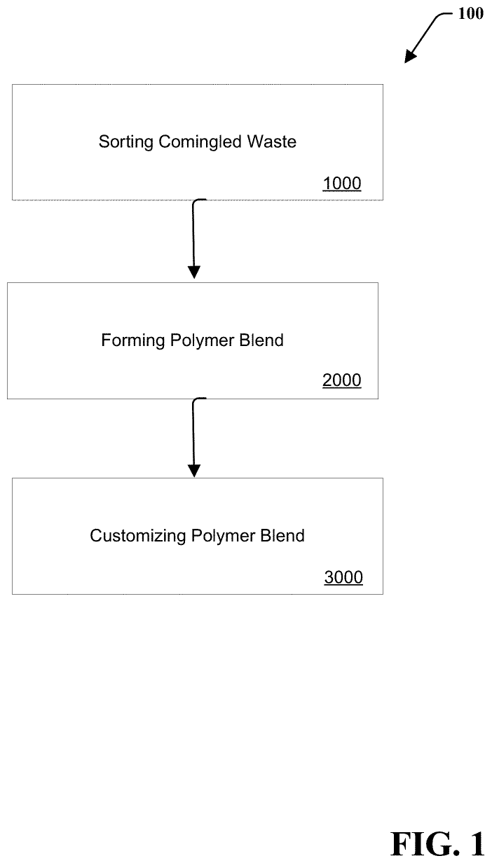

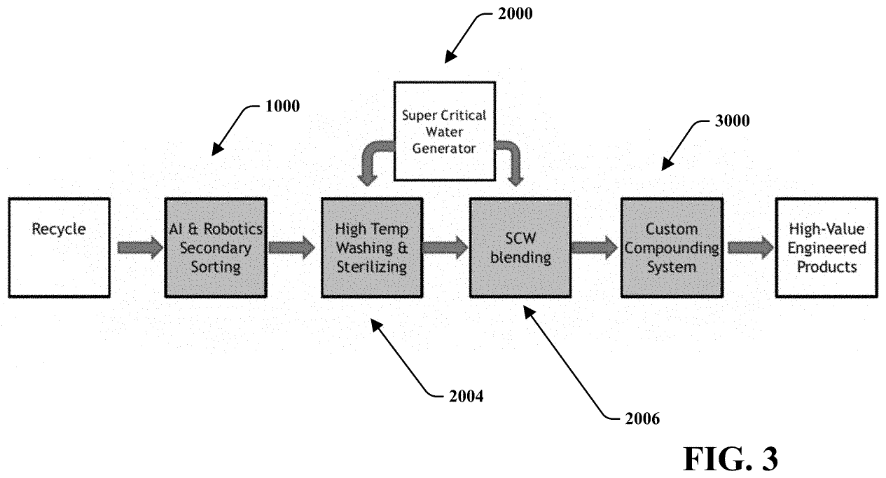

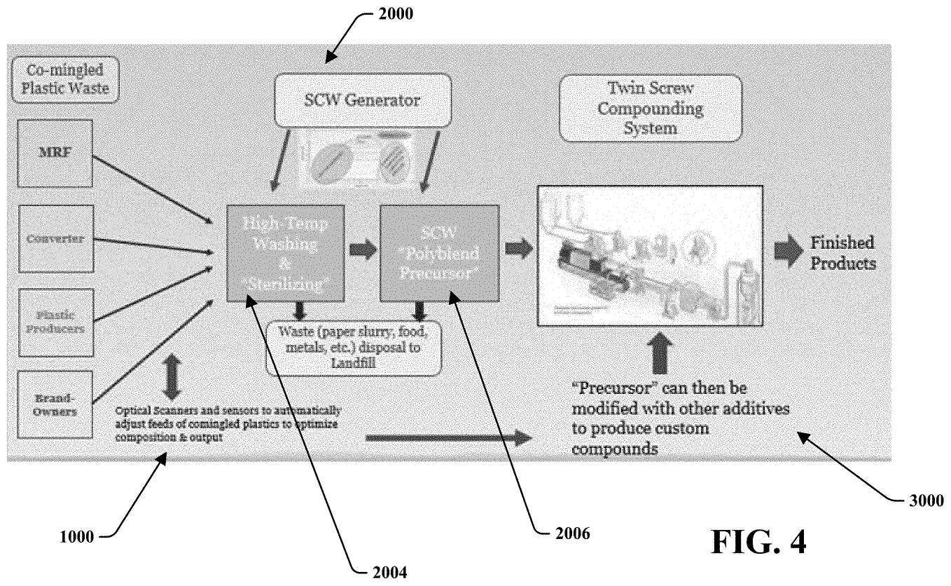

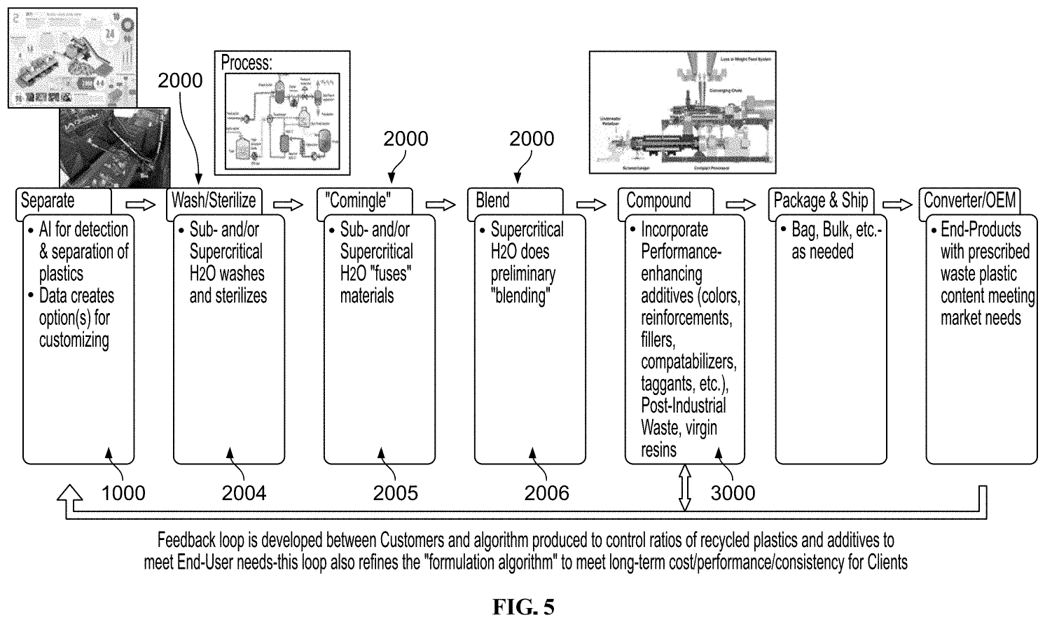

Although FIGS. 1-5 and the application may generally illustrate and describe various starting materials (different types of co-mingled waste, plastics waste, sorted polymer group waste, etc.) and ending materials (sorted polymer group waste, homogenous polymer blend precursor, custom plastic blend with additives, end products comprised of the recycled plastic, etc.) it is noted that each described step or combination of steps (artificial intelligence and robotics sorting, grinding, supercritical or subcritical (or near supercritical or subcritical) processing, extrusion, customization, reuse, etc.) may be isolated and combined with other processes, known or unknown, without departing from the invention.

For example, the sorting processes are not limited to plastics or polymer groups, and may be applicable to sorting any other types of waste, including different types of glass, paper, metals, compost, combinations of two or more thereof, and the like. The disclosed sorting may be used to identify and separate comingled waste on a macro level, e.g. between plastics and paper, which may also be referred to as primary sorting or may be used to identify and separate comingled waste on a molecular level, e.g. between polyolefins, polyesters, and polyamides, which may also be referred to as secondary sorting. Moreover, the disclosed sorting processes may be used with other recycling methods that do not require the supercritical processing or customization.

Similarly, the present subcritical and supercritical (or near subcritical or supercritical) processing systems and method may be used with other materials and without being limited to a select set of waste plastic material obtained via artificial intelligence or robotically sorted plastics. It may, however, be beneficial to employ a group or set of plastic waste material of a known chemical makeup as certain polymeric materials may not be sufficiently compatible to provide a useable recycled material.

Moreover, customization and the inclusion of additives in the final recycled material is optional and based on the particular purpose, intended use, or application of the recycled plastic material by an end user or for a particular industry. As a result, the disclosed recycling process may include one or more of the various disclosed steps herein.

It is also noted that the order of the disclosed steps herein may be modified without departing from the invention. For example, sorting may occur after supercritical or subcritical processing or after customization, customization may occur prior to sorting or supercritical or subcritical processing, etc. It is noted that any reference to subcritical or supercritical fluids or processes may also include near subcritical or supercritical fluids or processes unless context suggests or this description states otherwise.

Turning to FIGS. 1-5, a sorting process 1000 is described. The sorting process 1000 may include primary sorting into types of recyclable materials, secondary sorting into types of polymer groups, or both. The sorting process 1000 may additionally or alternatively include tertiary sorting within a polymer group. In an embodiment, the sorting process 1000 may include primary sorting and use comingled waste of different materials, including two or more of plastics, glass, paper, metal, compost, and other waste, for example. The sorting process 1000 may identify and separate this comingled waste into the separate groups of plastics, glass, paper, metal, compost, and other waste, for example.

In an embodiment, the sorting process 1000 may include secondary sorting and use comingled waste of different plastic materials, including, for example, two or more of polyolefins, amorphous polymers, polyesters, polyamides, crystalline and semi-crystalline polymers, and other polymer groups. The sorting process 1000 may identify and separate this comingled plastic waste into the separate groups of polyolefins, amorphous polymers, polyesters, polyamides, and other polymer groups, for example. In an embodiment, the sorting process 1000 may additionally or alternatively identify and sort two or more polymer groups into the specific polymers. Sorting the comingled waste of different plastic materials into polymer groups, may allow for easier processing by taking advantage of the other process components to produce the recycled plastics. For example, different classes or groups of polymers may not be compatible with one another or may require different processing conditions to form the final recycled material after the supercritical or subcritical water treatment.

As non-limiting examples, polyolefins may include polyethylene (PE), polypropylene (PP), thermoplastic olefin (TPO), polymethylpentene (PMP), polybutene-1 (PB-1), polyisobutylene (PIB), ethylene propylene rubber (EPR), ethylene-octene copolymers, olefin block copolymers, propylene-butane copolymers, poly(a-olefin)s, ethylene propylene diene monomer (EPDM) rubber, and the like. Polyethylene (PE) may itself include additional subgroups of high density polyethylene (HDPE), low density polyethylene (LDPE), linear low density polyethylene (LLDPE), very-low-density polyethylene (VLDPE), ultra-low-density polyethylene (ULDPE), medium-density polyethylene (MDPE), etc. Polypropylene (PP) may also include polypropylene homopolymer, polypropylene copolymers such as polypropylene random copolymers and polypropylene block copolymer, polypropylene impact copolymers, expanded polypropylene, polypropylene terpolymer, high melt strength polypropylene (HMS PP), etc. It is noted that the above list is not exhaustive.

As non-limiting examples, amorphous polymers may include acrylonitrile butadiene styrene (ABS), styrene acrylonitrile resin (SAN), polystyrene (PS), expanded polystyrene (EPS), polycarbonate (PC), polymethyl methacrylate (PMMA) or acrylic, etc. It is noted that the above list is not exhaustive.

As non-limiting examples, polyesters may include polyethylene terephthalate (PET), polybutylene terephthalate (PBT), polytrimethylene terephthalate (PTT), polyethylene naphthalate (PEN), polyglycolide or polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polyethylene terephthalate glycol (PETG), vectran, terylene, copolyesters, etc. It is noted that the above list is not exhaustive.

As non-limiting examples, polyamides may include nylons, aramids, sodium poly(aspartate), Kevlar, etc. Nylon may also include poly(hexamethylene adipamide) (Nylon 6,6) and polycaprolactam (Nylon 6). It is noted that the above list is not exhaustive.

It is noted that other polymer families, or other compound families other than polymers, may similarly be sorted and utilized. Non-limiting examples include the polyaryletherketone (PAEK) family, which may further include polyetherketones (PEK), polyetheretherketones (PEEK), polyetherketoneketones (PEKK), polysulfone (PSU), polyvinyl chloride (PVC), polyetherimide (PEI), etc. It is noted that the above list is not exhaustive.

The sorting process 1000 may include robotics and/or artificial intelligence to identify the types or category of plastic material for the waste plastic material and facilitate separation of the waste plastic material into particular groups. The sorting process 1000 may include optical scanners and sensors to automatically adjust feeds of comingled plastics to obtain the desired categorization and sorting into, for example, polymer groups. The optical scanners and sensors may include, but are not limited to, photo-imaging sensors, infrared sensors, ultra-violet sensors, and the like. Although optical evaluation is generally described, it is also noted that other evaluation may also be used, including melting point analysis, chemical reaction processes, etc. The sorting process 1000 may include an algorithm and sorting structure, including conveyors, detection devices, imaging devices, classification devices, sorting devices, and similar devices to identify and sort the comingled waste into desired sorted categories of materials. The algorithm may include machine learning techniques and software so that the sorting process 1000 evolves over time and is able to better evaluate and classify types of waste based on accuracy, efficiency, or similar. As further discussed herein, data may also be collected from other steps of the process on the front-end, including secondary sorting, subcritical and supercritical treatments, compounding, etc. (front-end data) or from the end users, manufacturers, or brand owners (back-end data) to further enable development and optimization of the recycling process and formulations in general and as they relate specifically to certain users, clients, and industries. Traceability and back-tagging of certain lots and formulations may also provide usable data, coupled with performance, feedback from customers, needs of the industry, etc., to be re-integrated into the artificial intelligence systems.

The sorting process 1000 may also include a processor, memory, and other computer components. As an example, comingled plastic waste may be arranged on a conveyor belt. The comingled plastic waste may include any recycled plastic items including, but not limited to, jugs, buckets, bottles, bottle caps, packaging, shopping bags, straws, cutlery and dishware, hangers, cassette and videotapes, toys, food and household containers such as condiment and detergent bottles and lids, plastic components of electrical, automotive, or industrial systems, certain polyester or nylon clothing and fabrics, fishing line, drink lids, gloves, masks, etc. Robotics may distribute the comingled plastic waste items onto the conveyor belt so that the items do not overlap and are able to be imaged individually. The items may then proceed on the conveyor belt to an imaging device. The imaging device may include one or more cameras, or imaging or scanning devices generally, configured to take an image or scan of the items. In an embodiment, the imaging or scanning devices may include x-ray crystallography, NMR spectroscopy, electron microscopy, atomic force microscopy, fluorescence (infrared, UV) or other optical imaging, or similar in order to identify chemical structures of the items. In an embodiment, any appropriate imaging or scanning device may be used that is able to capture whatever sorting criteria may be desired, for example, sorting by color, by components, by chemical structure, by molecular weight, etc. In one embodiment, the scanning or imaging device may be configured to detect markings or codes on a plastic product indicating the general makeup or grade of the plastic material. Such examples may include the number codes widely employed to identify the grade/category of plastic material from which the product is made.

The resulting image or scan may comprise raw imagery. This raw imagery may be automatically processed. For instance, the algorithm and processor may optionally isolate the singular items in the image, remove the background, magnify or redefine the image, and the like in order to prepare the image for further processing and evaluation. The refined imagery may then be processed and evaluated by a classification device and software to identify a threshold criteria. The threshold criteria may be based upon chemical structures, in an example, and may be used to differentiate between polymer groups. The threshold criteria may be inputted by a user or stored in the memory. In an example, the classification device and software may be programmed to determine the presence or absence of a ring structure, amide, or other functional groups, and the like.

Based on the evaluation of the polymer structure, in an example, the processor may then generate instructions detailing how and where the item should be sorted. A downstream sorting device may execute instructions and guide the item to the desired location, for instance, onto a particular conveyor belt or into a bin of like polymer items. It is noted that various sensors and detection devices may be used throughout the sorting process 1000 to track a particular item from the imaging device to the sorting device. Although sorting based on polymer groups and evaluation criteria of chemical structure are generally described, it is noted that sorting may be based on any other factor as desired and that the evaluation criteria may be modified based on the identifying elements that enable sorting of the comingled waste into desired categories.

After the groups are sorted, another system may be included with scanners, sensors etc. to further quantify the chemical makeup or other physical or chemical properties of the respective sorted waste plastic materials prior to processing.

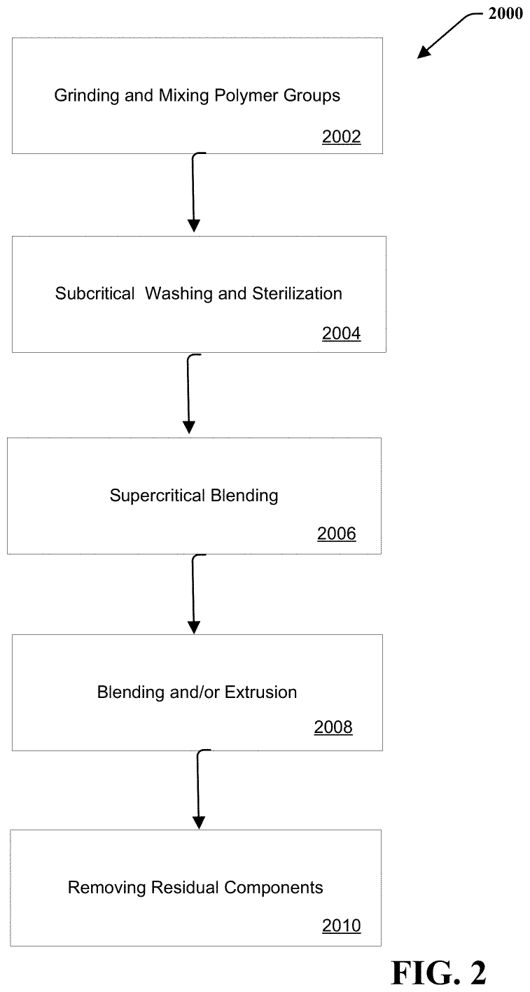

After sorting of comingled waste 1000 as described above and as shown in FIGS. 1 and 3-5 or as an independent recycling process as shown in FIG. 2, a mechanical blending process 2000 is described to form a polymer blend. It is noted that any of the described processes may be carried out in the same vessel or in separate vessels, and in separate vessels that may be positioned in series or in parallel as desired. The polymer blend may be homogenous or relatively homogenous and used as a precursor to other downstream recycling steps including customization and remanufacturing. In an embodiment, the mechanical blending process 2000 may utilize raw plastic waste that has been sorted into polymer groups. The respective sorted polymer waste material groups are generally separately treated to provide separate precursor blends. For example, a sorted polymer waste material group comprising polyolefins will most likely be subject to the supercritical or subcritical water treatment process separately from a group of sorted polymer waste that includes PET materials, to form a polyolefin precursor blend and a PET polymer blend. It is noted that these blends may be later combined during the customization step.

The sorted polymer waste material can be subjected to initial processing, such as grinding and mixing 2002, to obtain a smaller component mix of the sorted polymer group waste.

Once at a sufficient size, the ground polymer group waste may be granulated and fed into a subcritical water processing chamber to wash out contaminants and sterilize the plastics in the stream 2004. In an embodiment, this subcritical water processing may also serve to blend the plastics in the stream and provide a blended polymer group waste also referred to herein as a precursor polymer blend or a precursor plastics blend without conditions reaching a supercritical state. In another embodiment, the washed and sterilized polymer group waste may then be conveyed to an agitated supercritical water (SCW) vessel for blending 2006 to provide a blended polymer group waste also referred to herein as a precursor polymer blend or a precursor plastics blend. For example, there may be instances where the conditions of the subcritical water processing 2004 (e.g. near supercritical), the types of the polymer waste, reactor size, the amount and ratio of polymer waste to water, the amount of agitation, the time of processing, etc., result in the desired blended product, foregoing the need for a supercritical processing step 2006. There may be other instances where the conditions of the subcritical water processing 2004 do not necessarily result in the desired blended product or where additional processing is desired, and the conditions can be thereby ramped up to supercritical conditions.

In an embodiment, the supercritical blending 2006 may comprise water as the supercritical fluid or universal solvent. The supercritical water may include conditions at or greater than (i) a temperature of 373° C. and (ii) a pressure of 3190 psi. In an embodiment, for these supercritical conditions to be met, both the temperature and the pressure must satisfy the preceding numerical ranges or must satisfy exceed critical points in both temperature and pressure to be considered above the critical point of the fluid and being a supercritical fluid.

In an embodiment, the subcritical processing 2004 (e.g. washing, sterilizing and/or blending) may comprise water as the subcritical fluid. The subcritical water may include conditions that are not considered supercritical or that are less than the supercritical conditions, e.g., less than (i) a temperature of 373° C. and/or (ii) a pressure of 3190 psi. The subcritical water may include conditions at or around (i) a temperature of from about 110 to about 372° C., about 225 to about 350° C., about 250 to about 325° C., about 290 to about 320° C., or about 300 to about 310° C., and/or (ii) a pressure of from about 700 to about 3100 psi, about 750 to about 3000 psi, about 800 to about 2500 psi, about 900 to about 2000 psi, or about 1000 to about 1200 psi, and the like. It is noted that if the only one of the conditions of temperature or pressure need fall within these preceding subcritical ranges to be considered subcritical. The subcritical processing 2004 and/or supercritical blending 2006 may be of a sufficiently short duration or short time depending on the particular polymer group waste being processed. In an embodiment, the short duration or time of supercritical blending 2006 may be from 1-60 minutes. It is noted that chemical recycling, on the other hand, can require several hours to obtain broken-down monomer product.

In an embodiment, the resulting or processed blend may have has the same plastic properties or identity as the initial sorted polymer waste material, e.g. polypropylene is still polypropylene, etc. The supercritical blending 2006 may provide low-shear melt blending of the polymer group waste to facilitate production of a homogenous or semi-homogenous precursor polymer blend. The supercritical blending 2006 may also improve compatibility of the polymer group waste, for example, in respect to different types of polyolefins, including from HDPE containers, PP bottles, LLDPE films, etc.

The subcritical washing/sterilizing 2004 and supercritical blending 2006 may be beneficial in providing more optimized time, temperature, and pressure to enable mechanical blends of the polymer group waste to be produced (i.e., forming a precursor polymer blend) without substantial degradation of aesthetic, mechanical, or physical properties.

Both steps of subcritical washing/sterilizing 2004 and supercritical blending 2006 may occur in a supercritical water (SCW) generator. It is noted that reference to subcritical and supercritical conditions in steps 2004 and 2006 can include approximate or near subcritical and supercritical conditions unless context suggests or this description states otherwise. Either or both steps of washing/sterilizing 2004 and blending 2006 may result in expelling undesired waste components or contaminants, including paper slurry, e.g. from labels on plastic containers, food, metals, etc. for disposal into a landfill or for further processing in other recycling systems. Without being bound to any particular theory or mechanism, the supercritical fluid or subcritical fluid, such as water, may also “fuse” materials 2005 to further assist in the blending and processing of the precursor polymer blend. Unlike other systems and processes to treat/recycle plastic materials, the present process does not break the polymeric materials down into their monomeric components, which would require re-polymerization of the monomer to provide a recycled polymeric material. While not being bound to any particular theory, the present process in producing the precursor blend provides a co-mingled polymeric material that can be solubilized and blended. This may provide more rheologically compatible materials.

It will be appreciated that sensors and other equipment, such as described above with respect to the sorting operation, can be employed to monitor and evaluate the precursor blend produced via the treatment operation.

After supercritical blending 2006 to provide a precursor polymer blend, the precursor polymer blend may then be conveyed into a system 2008 for further compounding. The compounding system 2008 is not particularly limited and can include any system or apparatus suitable for compounding plastic materials. In one embodiment, the compounding system 2008 includes an extruder. In an embodiment, this additional extruding and blending 2008 of the precursor polymer blend may be carried out by a twin-screw extruder, continuous mixer, or other appropriate melt-combination system. The precursor polymer blend may then have any residual components removed 2010 such as residual fluid or water and other low-molecular weight materials.

The compounding system may include a customization process 3000 to form a customized, value-added material, also referred to herein as a value-added recycled plastic material or custom plastic blend. At this customization step, the precursor polymer blend can be modified with other additives to produce custom compounds. In an example, virgin polymeric material or performance-enhancing additives may be incorporated into the precursor polymer blend as desired for a particular purpose or intended application. Virgin polymeric material may be added to adjust the polymeric composition to provide desired properties to the polymer or to meet particular end user specifications. Other additives may be added to adjust the properties or appearance of the final recycled product. Examples of suitable additives include, but are not limited to, colorants, reinforcements (e.g. glass fibers, carbon fiber, natural fibers, etc.), fillers (e.g. organic, inorganic, varying in size and shape), impact modifiers, processing aids, compatabilizers, ultra-violet or chemical taggants, identifiers, etc. to provide a value-added material or custom plastic blend. In another example, post industrial wastes or ratios of virgin resins or plastics may be incorporated into the precursor polymer blend to provide a value-added material or custom plastic blend.

It is noted that the value-added material or custom plastic blend may include one or more of any performance-enhancing additive, post industrial wastes, or ratios of virgin resins as may be desired. For example, remanufacturing of the recycled plastic may require or prefer certain qualities, e.g. physical or chemical properties that may not be present in the precursor polymer blend obtained from the treatment operation but that are desired for a particular industry, client, remanufacture, or the like. By adding industry or client-preferred additives, the flexibility and value of the precursor polymer blend may be enhanced or broadened so that the recycled plastic may act most similarly to virgin plastics. Additionally, the use of taggants or identifiers may help identify particular batches of the recycled plastics for quality control, to distinguish polymer groups, or to distinguish additives or overall formulations, as well as to identify counterfeit or third party materials.

After the value-added material or custom plastic blend has been produced 3000, its physical properties, mechanical properties, chemical compositions, etc. can be characterized by quality control methods and the resulting data from the value-added material or custom plastic blend may be integrated with the raw material information collected by the sorting process 1000 and artificial intelligence system on the front-end of the recycling process 100. As a result, each value-added material or custom plastic blend will be able to be traced by its material, process, and batch. As stated herein, this may be beneficial to the remanufacturers in identifying preferred formulations and performance enhancements as well as to the recycler in the ability to detect counterfeiting.

Over time, collection of the data on the incoming recycled plastics and comingled waste, the primary and/or secondary sorting processes 1000, subcritical washing and sterilizing 2004, supercritical blending 2006, the custom compounding system 3000, and performance of each of the value-added materials or custom plastic blends, in each of the polymer groups, will allow for further refinement and optimization of the recycling process 100 and preferred formulations of recycled plastics to be used or deduced by the artificial intelligence and re-implemented into the recycling process 100 by the artificial intelligence. In other words, a feedback loop is developed between customers and the algorithm produced to control ratios and formulations of the recycled plastics for remanufacture to meet end-user needs. These feedback loop also refines and adjusts the algorithm by means of the artificial intelligence to meet long-term cost, performance, consistency, and improvement for the end users.

Further, not only might the feedback loop further optimize processes, algorithms, formulations used or produced in the recycling process 100, but moreover, such value-added material or custom plastic blend based on industry needs and preferences may ultimately provide a certified recyclable product enabling consumers and end users to have a reliable and sustainable source of recycled plastics for remanufacture that promote the continued use of recycled plastics. This would not only provide the benefits associated with plastics, plastic manufacture (cost-effective, durable), plastics consumerism (sterile, single-use), but also offset the negative environmental impact associated with virgin plastics (overproduction resulting in litter and landfill waste, greenhouse gas emissions during manufacture, etc.)

The present systems and methods can be scaled, customized, and can be provided in various sizes or iterations to accommodate different regions where it is implemented. For example, different regions may produce different quantities of waste material, and the size and/or number of sorting and treatment systems can be selected accordingly to accommodate particular levels of waste. Additionally, the system can be sized or scaled to provide to allow for recycling and creation of precursor blends on site at a selected location, plant, etc. In one embodiment, described systems and methods may be scaled so as to enable processing on a ship or other customized watercraft to collect, for example, marine plastic waste and process into high value or value-added precursor blends. This may similarly be scaled onto a lake or seagoing vessel, or in crowded, high density land areas where space may be limited. The present systems and methods can also be scaled up to accommodate large industrial processes or act as a hub for a larger geographical area. To this end, the vessels and scale of the systems and methods can be scaled and customized as desired.

The source of the waste is not particularly limited and can be selected as desired for a particular purpose or intended application. For example, the source of the waste being collected could be from individual cities, counties, regions, etc. The quantity of different types of plastics may vary in different regions of a city, county, state, or country based on different consumption habits of inhabitants within a particular region or based on particular industries located within a region. The source waste being collected may also, for example, include post-consumer waste, post-industrial waste, or any combination of the two. Post-industrial waste may generally include materials made and utilized during a manufacturing process but that do not become a part of the consumer product or end product (e.g. scrap materials). Thus, the present system allows for the creation of different types of recycled plastic material based on the region where the waste material is collected.

In one embodiment, the source of the waste material can be restricted to plastic waste materials from a specific source, such as, for example, a particular brand owner. The waste materials can be collected at various locations and then shipped to a particular facility for treatment to recycle the material in accordance with aspects of the present technology. In this way, brand owners or a plastics converter can control the input and use the recycled material to make new products, containers, etc.

In other embodiments, by knowing what is going into the system based on the evaluations made at the sorting stage, the process lends itself to semi-batch processing to make “lots” of materials of a given composition. That is, by knowing the ratios of the respective types of polymers being input into the treatment system, 1 to X lots of material of a given chemical make up can be provided.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

1. A process for recycling plastic materials comprising: treating a set of plastic materials with a fluid under (i) subcritical conditions and/or (ii) supercritical conditions to provide a precursor blend of plastic, wherein the fluid is water.

2. The process of claim 1, wherein the subcritical conditions include a temperature of about 110-372° C. or a pressure of about 700-3100 psi.

3. The process of claim 1, wherein the subcritical conditions include a temperature that is greater than the melting point of the plastic materials.

4. The process of claim 1, wherein treating further comprises mechanically blending the plastic materials during treatment with the fluid.

5. The process of claim 1, wherein set of plastics comprises a single type of polymeric material.

6. The process of claim 5, wherein the single type of polymeric material comprises two or more monomeric components.

7. The process of claim 1, wherein the set of plastics comprises two or more types of plastic materials.

8. The process of claim 1, wherein the precursor blend of plastic is a homogenous blend.

9. The process of claim 1, wherein the set of plastic materials is not broken down into their monomeric components.

10. The process of claim 1, wherein the set of plastic materials comprises at least one plastic selected from a polyolefin, an amorphous polymer, a polyester, a polyamide, or a combination of two or more thereof.

11. The system of claim 1, wherein the set of plastic materials include a plastic selected from polyethylene (PE), polypropylene (PP), thermoplastic olefin (TPO), polymethylpentene (PMP), polybutene-1 (PB-1), polyisobutylene (PIB), ethylene propylene rubber (EPR), ethylene-octene copolymers, olefin block copolymers, propylene-butane copolymers, poly(a-olefin)s, ethylene propylene diene monomer (EPDM) rubber, high density polyethylene (HDPE), low density polyethylene (LDPE), linear low density polyethylene (LLDPE), very-low-density polyethylene (VLDPE), ultra-low-density polyethylene (ULDPE), or medium-density polyethylene (MDPE), or a combination of two or more thereof.

12. The system of claim 1, wherein the set of plastic materials comprises a plastic material selected from polyethylene (PE), polypropylene (PP), or a combination of polyethylene (PE) and polypropylene (PP).

13. A method for recycling plastic materials comprising:
sorting co-mingled plastic waste into one or more groups of a set of plastics,
grinding and mixing the set of plastics into a mix,
subjecting the set of plastics to the process of claim 1 to provide a precursor blend of plastic;
conveying the precursor blend of plastic to compounding equipment;
removing residual fluid or water and other low-molecular weight materials;
and optionally incorporating other additives or unrecycled plastics to provide specific physical, thermal, mechanical, or aesthetic properties in a value-added recycled product.

14. The method of claim 13, wherein the precursor blend is homogenous.

15. A system for recycling plastic materials comprising:
a sorting system for separating co-mingled plastic materials into one or more groups of sorted plastic materials based on selected characteristics of the sorted plastic materials;
a treatment system for treating one of the one or more groups of the sorted plastic materials via supercritical or subcritical fluid to create a precursor blend; and
a compounding system for compounding the precursor blend to provide a recycled plastic material.

16. The system of claim 15 further including a pre-sorting system for separating co-mingled waste including two or more of glass, paper, metals, compost, plastics, and combinations of two or more thereof, wherein the co-mingled plastic materials are isolated from the co-mingled waste.

17. The system of claim 15, wherein the sorting process includes at least one of artificial intelligence and robotics.

18. The system of claim 15, wherein the one or more groups of sorted plastic materials include a polyolefin, an amorphous polymer, a polyester, a polyamide, or a combination of two or more thereof.

19. The system of claim 15, wherein the one or more groups of sorted plastic materials comprises a plastic material selected from polyethylene (PE), polypropylene (PP), thermoplastic olefin (TPO), polymethylpentene (PMP), polybutene-1 (PB-1), polyisobutylene (PIB), ethylene propylene rubber (EPR), ethylene-octene copolymers, olefin block copolymers, propylene-butane copolymers, poly(a-olefin)s, ethylene propylene diene monomer (EPDM) rubber, high density polyethylene (HDPE), low density polyethylene (LDPE), linear low density polyethylene (LLDPE), very-low-density polyethylene (VLDPE), ultra-low-density polyethylene (ULDPE), or medium-density polyethylene (MDPE).

20. The system of claim 15, wherein the one or more groups of sorted plastic materials comprises a plastic material selected from polyethylene (PE), polypropylene (PP), or a combination of polyethylene (PE) and polypropylene (PP).

21. The system of claim 15, wherein the treatment system includes an initial processing step of grinding and mixing the sorted plastic materials to obtain a component mix of the sorted plastic materials.

22. The system of claim 15, wherein the treatment system includes a sterilization step, wherein the component mix of the sorted plastic materials are inputted into a subcritical water processing chamber to obtain a sterilized component mix of the sorted plastic materials.

23. The system of claim 15, wherein the treatment system includes a subcritical and/or supercritical processing step, wherein the sterilized component mix of the sorted plastic materials are inputted into a subcritical and/or supercritical water processing chamber to provide the precursor blend.

24. The system of claim 23, wherein the subcritical water processing chamber and the subcritical and/or supercritical water processing chamber are the same vessel.

25. The system of claim 23, wherein the precursor blend is homogenous.

26. The system of claim 23, wherein the subcritical processing step occurs at a temperature of 110-372° C. or a pressure of 700-3100 psi.

27. The system of claim 23, wherein the precursor blend has the same plastic properties or identity as the one or more groups of sorted plastic materials.

28. The system of claim 15 further comprising adding at least one additive to the precursor blend to provide a value-added blend.

29. The system of claim 28, wherein the at least one additive is a colorant, flame retardant, filler, fiber, chemical identifier, tracker, or taggant.

30. The system of claim 28, wherein the at least one additive provides at least one of an added physical property or aesthetic property that is not present in the precursor blend.

31. The system of claim 15 further comprising adding virgin or unrecycled plastics to the precursor blend to provide a combination blend.
